(19) United States
(12) Patent Application Publication
(10) Pub. No.: US 2003/0150682 A1
(43) Pub. Date: Aug. 14, 2003

(54) Method for forming frictional surface of lockup clutch

(75) Inventors: Tatuo Yokodana, Fukuroi-shi (JP); Kazuo Sakai, Shizuoka-ken (JP); Toshiaki Wakisaka, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 10/357,469

(22) Filed: Feb. 4, 2003

(30) Foreign Application Priority Data
Feb. 14, 2002 (JP) 2002-36740

(51) Int. Cl. F16D 33/00

(52) U.S. Cl. 192/3.29

(57) ABSTRACT

A method for forming the frictional surface of a lockup clutch, in which a friction material is given cutting process for the formation of the frictional surface, comprises the step of performing said cutting process in oil.

### BACKGROUND OF THE INVENTION

1. Field of the Invention

The present invention relates to a method for forming the frictional surface of the lockup clutch of a torque converter used for the automatic transmission of an automobile or the like.

2. Related Background Art

The automatic transmission of an automobile or the like has conventionally been structured with a torque converter and a transmission mechanism. The rotation of an engine is then transmitted to an input shaft through the torque converter, and it is further transmitted to the transmission mechanism. Here, a pump impeller, a turbine runner, a stator, and a lockup clutch form the torque converter in general.

The rotation of the engine is transmitted to a front cover, and transmitted to the pump impeller fixed to the front cover. With the rotation of the pump impeller, the rotational flow occurs in oil inside the torque converter, which rotates around the shaft. This flow of oil is allowed to circulate among the pump impeller, the turbine runner, and the stator by means of centrifugal force.

The stator lies between the pump impeller and the turbine runner, and functions to change the flow of oil in the direction in which it can assist the rotation of the pump impeller if difference in rotating speeds of both of them is made greater. When the difference in the rotating speeds of the pump impeller and the turbine runner is made smaller, the stator begins to rotate by the action of a one-way clutch so as not to impede the flow of oil. In this way, the torque converter transmits the rotation of the engine to the input shaft.

However, the transmission of the rotation of engine to the input shaft through oil during the traveling of a vehicle is not favorable in terms of transmission efficiency. Therefore, the lockup clutch is provided to engage with the front cover at a predetermined speed of a vehicle in order to transmit the rotation of engine to the input shaft directly.

For the lockup clutch, friction material is fixed to the surface that frictionally, engages with the front cover. However, then, the surface of the friction material has fluffs resulting from the extruded fiber mixed in resin at the earlier stage of its formation, and when it is used for the lockup clutch, the contact area with the inner face of the front cover is made smaller to reduce the friction coefficient.

Also, in general, the μ-v (dynamic friction coefficient-velocity) characteristic is arranged to present such condition that when the rotational number of slips is smaller, the friction coefficient is made smaller, and that if the rotational number of slips is larger, the friction coefficient is made larger. If the friction material that may present such characteristics is used as it is for a lockup clutch, there is a fear that vibrations take place due to stick slips when beginning to effectuate the engagement of the lockup clutch and also, when beginning to release it.

As means for solving such problem as this, there has been proposed cutting the surface of the friction material. Here, for example, a lockup clutch is disclosed in the specification of Japanese Patent Laid-Open Application 05-99297. FIG. 7 is a front view that shows a typical lockup clutch piston. FIG. 8 is a cross-sectional view thereof, taken in its axial direction.

The lockup clutch piston 30 is substantially a circular member provided with an opening portion 32 at the center thereof, which penetrates the piston in the axial direction. To the frictional surface 31 arranged to face the front cover (not shown), the friction material is adhesively bonded. Also, for the backside of the lockup clutch piston 30, that is, the opposite side of the frictional surface 31, the fitting nail 33, which is shown in FIG. 8, is provided to order to fit the lockup clutch piston 30 in a predetermined position.

(1) In a case where the usual cutting is performed on the frictional surface 31 of friction material as disclosed in the specification of Japanese Patent Laid-Open Application 05-99297, the surface of the friction material is burned due to frictional heat or the change of state takes place on the surface of the friction material, thus creating a problem that the anticipated characteristic of friction is affected eventually. Also, there is a problem that the friction material or grinding stone is packed with chips when the surface of the friction material is cut.

(2) Also, the core plate used for the formation of the lockup clutch piston 30 is formed in a predetermined shape by means of punching or drawing. It may be given heat treatment in some cases. In these processes, slight deformation may be caused to remain on some occasion. The surface on the side where friction material is adhesive bonded is ground afterward so that it is made flat within a range of predetermined precision without any portion that may present deformation. In this respect, deformation may still remain slightly on the surface on the backside thereof, but such deformation does not produce any unfavorable effect on the performance of the lockup clutch at all. Here, therefore, any process that may be required for removing such deformation is dispense with economically.

Nevertheless, if it is intended to bond friction material having such deformation on the backside thereof, the friction material is given uneven load eventually due to the deformation of the core plate when the friction material is bonded (that is, when pressed and heated) as shown in FIGS. 9 and 10. Consequently, then, distortion remains on the frictional surface of the friction material.

The friction material 36 is bonded to the surface (frictional surface) of the core plate 35 by pressing and heating with a head 34 from the backside of the core plate 35 which has deformation as shown in FIG. 9. Thus, due to the deformation of the backside of the core plate 35, the friction material 36 is also deformed eventually. As shown in FIG. 10, this deformation 37 still remains on the surface of the friction material 36 even after the completion of bonding subsequent to pressurization given to the friction material 36. This deformation 37 or distortion of the friction material 36 cases judder to occur inevitably when the lockup clutch is enabled to slip in use.

Also, it is practiced to cut the surface of the friction material to make it flat as shown in the aforesaid specification of Japanese Patent Laid-Open application 05-99297. However, if a load at the time of cutting is great, the core plate is distorted (deformed) due to such load that has been given. Cutting is, then, effectuated in the distorted (deformed) condition after all. Therefore, in order to avoid such distortion or deformation completely by the application of the usual cutting method, the load should be made smaller at the time of cutting, and further, the period of cutting operation should be made longer, which presents another problem that the production efficiency is made lower inevitably.

### SUMMARY OF THE INVENTION

Therefore, the present invention is designed to aim at providing a method for forming the frictional surface of a lockup clutch capable of solving the problems referred to in the preceding paragraphs (1) and (2).

In order to achieve the object, the method of the present invention for forming the frictional surface of a lockup clutch, in which a frictional material is cut to form the frictional surface, comprises the step of performing the cutting process in oil.

Also, the method of the present invention for forming the frictional surface of a lockup clutch, in which a friction material is cut to form the frictional surface, comprises the step of performing the cutting process by giving only the load of work's own weight to a rotating grinding stone.

In accordance with the present invention, cutting process of friction material is performed in oil, thus making it possible to prevent the temperature from rising due to cutting.

Also, in accordance with the invention, the grinding stone and the work are relatively rotate in oil, and load is given by means of oil pressure to enable the grinding stone and the work to be in contact, thus preventing the temperature from rising due to cutting.

Further, in accordance with the invention, radially extended grooves are provided for the cutting surface of a grinding stone, hence making it possible to exhaust chips externally and prevent the friction material and grinding store from being packed by chips.

In accordance with the invention, in a method for forming the frictional surface of a lockup clutch that produces the frictional surface by cutting process given to a friction material, the cutting process is performed in such a manner that only the load of work's own weight is given to the rotating grinding stone. Thus, the process is executable without giving deformation to material, and highly precise flatness of the surface is obtainable.

In accordance with the invention, the aforesaid additional cutting is performed subsequent to the cutting process performed by giving only the load of work's own weight to the rotating grinding stone. Therefore, it becomes possible to obtain a flat frictional surface in a short period of time.

In the specification hereof, the phrase “frictional surface of a lockup clutch” indicates primarily the frictional surface of a lockup clutch piston, but also, indicates the frictional surface of a lockup clutch, as well as that of a related member used therefore.

### BRIEF DESCRIPTION OF THE DRAWINGS

FIG. 1 is a cross-sectional view that shows a cutting apparatus used for the performance that embodies the present invention.

FIG. 2 is a cross-sectional view that shows the grinding stone, which is used for the aforesaid cutting apparatus.

FIG. 3 is a plan view that shows the grinding stone, observed in the direction indicated by an arrow A in FIG. 2.

FIG. 4 is a plan view that shows the principal portion of a distortion removal apparatus.

FIG. 5 is a side view that shows the principal portion of an apparatus for removing distortion.

FIG. 6A is a side view that partially shows the state of a work before removing distortion.

FIG. 6B is a view that partially shows the state of the work when distortion being removed.

FIG. 6C is a side view that partially shows the state of the work after cutting.

FIG. 7 is a front view that shows a lockup clutch piston.

FIG. 8 is a cross-sectional view of the lockup clutch piston, taken in the axial direction.

FIG. 9 is a view that shows the bonding process of a friction material to a core plate (at the time of being pressed and heated).

FIG. 10 is a view that shows the bonding process of the friction material to the core plate (at the completion of bonding).

### DETAILED DESCRIPTION OF THE PREFERRED EMBODIMENTS

Hereinafter, with reference to the accompanying drawings, the detailed description will be made of each embodiment of the present invention. In this respect, the same reference marks are applied to the same parts in each of the accompanying drawings.

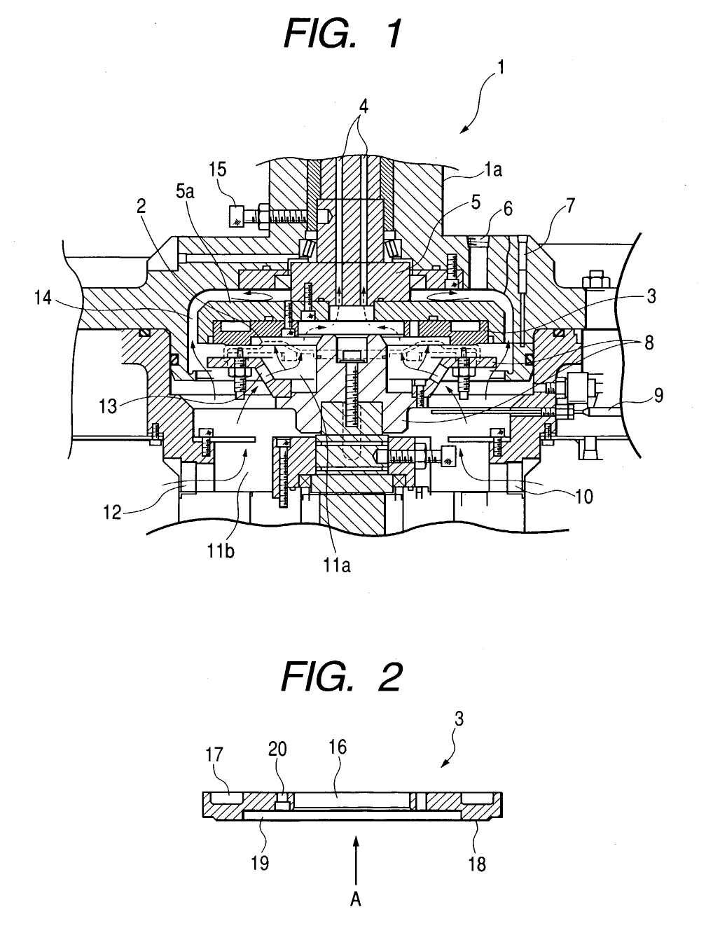

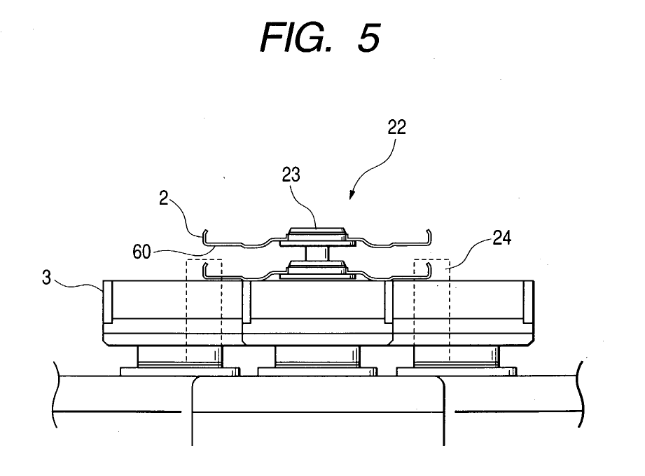

FIG. 1 is a cross-sectional view that shows a cutting apparatus that implements each of the embodiments of the present invention. The cutting apparatus 1 is provided with a grinding head 5 having a grinding stone 3 fixed with the grinding surface downward. On the down side of the grinding head 5, there is installed a work fixing jig 8 that holds the work 2 of a lockup piston in a state where the frictional surface thereof is arranged upward. The grinding head 5 is fixed to the housing 1a of the grinding apparatus 1 by means of a lock screw 15. On the fictional surface of the work 2, friction material 60 (see FIG. 5) is adhesively bonded.

The holding portion 5a that holds the grinding stone 3 of the grinding head 5 is housed in an oil chamber 14 installed substantially on the central portion of the grinding apparatus 1. Also, for the grinding head 5, an air vent 4 is provided, which is connected with a suction pump (not shown). For the housing 1a of the grinding apparatus 1, an air-blowing hole 7 is provided to send the air therein. The air that enters through the air-blowing hole 7 is exhausted to the outside from the air vent 4 of the grinding head 5 through the oil chamber 14.

For the housing 1a, there is further installed an oil vent 6 communicated with the oil chamber 14 to enable oil to be drawn out externally. The oil vent 6 is connected with a pump (not shown). Between the work fixing jig 8 and the work 2, and below the work fixing jig 8, oil chambers 11a and 11b are arranged, respectively. The oil chamber 11a and the oil chamber 11b are communicated with each other through an oil hole 13. Also, below the grinding apparatus 1, an oil supply holes 10 and 12 are arranged. In order to monitor the temperature of oil chamber, a temperature sensor 9 is arranged in the oil chamber 11b.

Oil that flows in the grinding apparatus 1 through the oil supply holes 10 and 12 enters the oil chamber 11b at first, and then, partly enters the oil chamber 11a through the oil hole 13, and also, partly enters the oil chamber 14. Oil that enters the oil chamber 14 is exhausted to the outside through the oil vent 6 after the completion of cutting operation. Here, an oil pressure-controlling device (not shown) controls the oil pressure in each of the oil chambers.

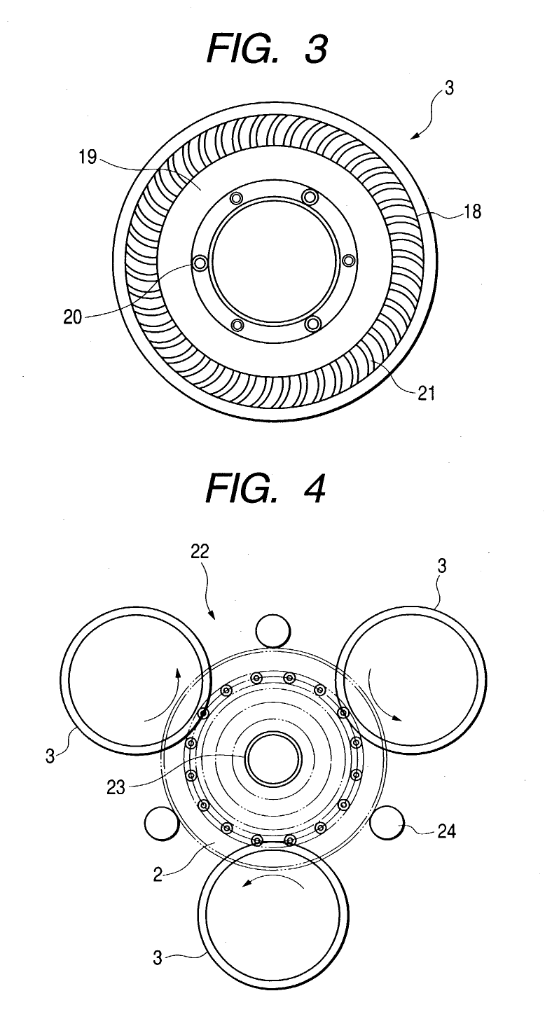

Next, the description will be made of the grinding store 3 used for the cutting apparatus 1. FIG. 2 is a cross-sectional view that shows the grinding store 3 used for the grinding apparatus 1. FIG. 3 is a plan view showing the grinding stone 3, observed in the direction indicated by an arrow A in FIG. 2. As obvious from the representations of FIGS. 2 and 3, the grinding stone 3 is substantially a circular member having the opening 16 on the central portion thereof, which penetrates it in the axially direction. On one end face in the axial direction, a circular groove 17 is cut, and on the other end face, a circularly recessed portion 19 is arranged. On the circumference of the recessed portion 19, the circular grinding-stone surface 18 is arranged protrusively. The grinding store 3 is fixed to the grinding head 5 by means of screws put through threaded holes 20.

On the grinding surface 18 of the grinding stone 3, plural numbers of radial grooves 21 are cut with curbs forming a predetermined angle in the circumferential direction as shown in FIG. 3. With these grooves 21, it is made easier to exhaust chips generated at the time of grinding to the outside, hence preventing friction material and grinding store from being packed. It is preferable to form the grooves 21 in the radial shape in order to make it easier to spread chips to the outer circumference by the centrifugal force generated by the rotation of the grinding stone 3, but it may be possible to form them in some other shape. For example, the grooves may be formed as those extending radially in straight lines.

Next, the description will be made of the operation of the grinding apparatus 1 that uses the grinding stone 3. At first, the work 2, which is the lockup clutch piston of the lockup clutch, is fixed to the work-fixing jig 8. Also, the grinding stone 3 is held to the holding portion 5a of the grinding head 5 with the grinding surface 18 downward, that is, to face the frictional surface of the work 2. In this state, the grinding head 5 rotates to generate relative rotations between the head and the work 2 in the static condition.

As described earlier, lubricant is supplied into the grinding apparatus 1 through the oil supply holes 10 and 12, and lubricant is filled inside the apparatus. Then, oil pressure is exerted from the backside (the surface where no friction material is bonded) of the work 2 by use of the oil chamber 11a to press the work 2 to the grinding stone 3 from below. At this juncture, it is arranged to enable the grinding surface 18 of the grinding stone 3 to abut against the frictional surface of the work 2 in parallel to each other. In this state, grinding stone 3 and the work 2 are allowed to rotate relatively for cutting the surface of the friction material of the work 2.

The cutting process of the cutting apparatus 1 is performed in lubricant as described above, thus making it possible to prevent the temperature from rising due to cutting. In this respect, with the temperature sensor 9, the oil temperature during the operation of the cutting apparatus 1 is monitored in order to avoid any excessive rise of the temperature. Here, also, it is arranged to enable the grinding head 5, that is, the grinding stone 3, to rotate, but it may be possible to arrange the structure so that the work 2 rotates while the grinding stone 3 is kept in the static condition.

FIG. 4 is a plan view that shows the principal portion of the distortion-removal apparatus 22 that removes distortion by grinding the surface of friction material. FIG. 5 is a side view that shows the principal portion of the distortion-removal apparatus 22. The distortion-removal apparatus 22 is provided with a lockup piston, that is, the positioning head 23, which is inserted into the opening portion of the work 2 to fixedly hold the work 2, and the positioning bar 24, which holds the work 2 at the outer circumference thereof. Three pieces of the positioning bar 24 are arranged equally in the circumferential directions. Here, it may be possible to arrange them in any other numbers.

As shown in FIG. 4, three grinding stones 3 are equally arranged on the circumference of the work 2, which is held in the state where the frictional surface thereof is put downward, and rotate in the predetermined direction. Arrows shown in FIG. 4 indicate the rotational direction. The grinding surface of the grinding stone 3, which is positioned below the work 2, is arranged to face the frictional surface adhesively bonded to the friction material 60 of the work 2. It should be good enough if either one of the positioned head 23 and the positioning bar 24 is provided, but both of them may be provided. In either case, only the weight of the work 2 own is given to the grinding stone as a load.

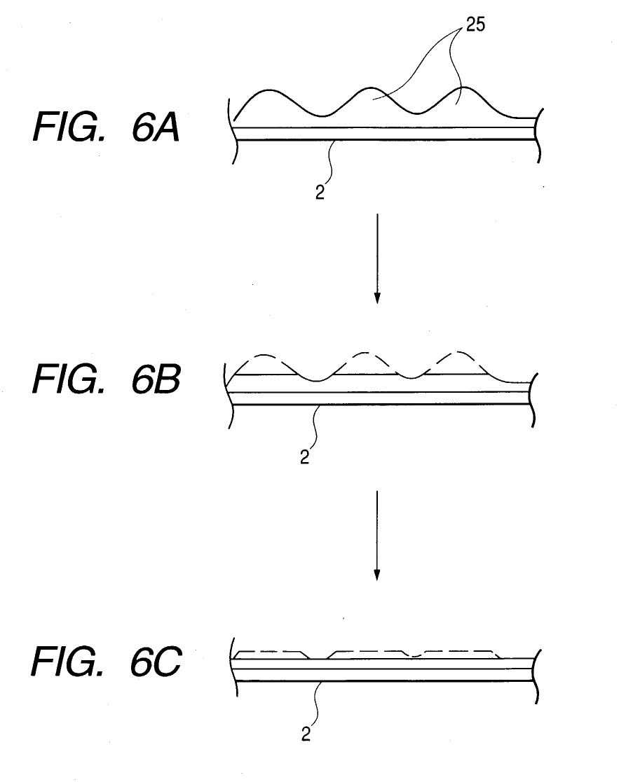

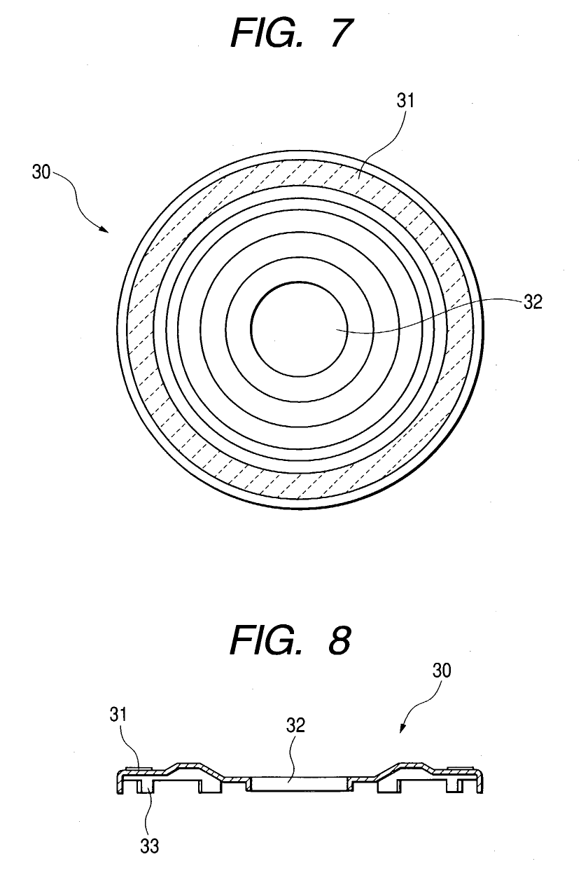

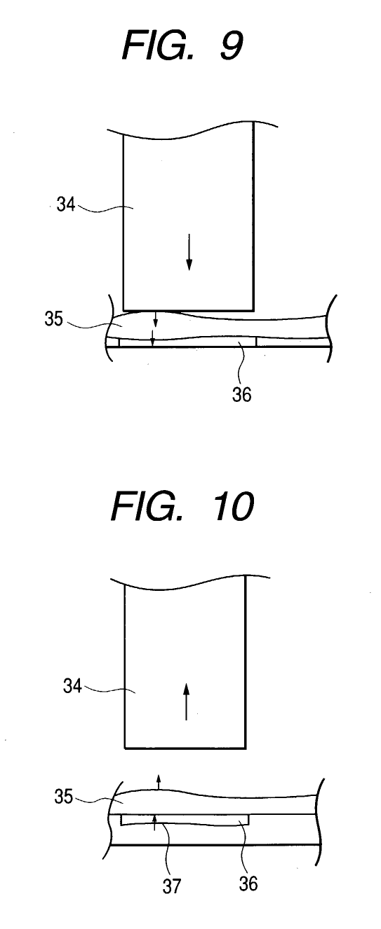

Next, in conjunction with FIGS. 6A to 6C, the description will be made of the state where distortion is being removed by use of the distortion-removal apparatus 22. FIG. 6A is a side view that partially shows a state before distortion is removed. FIG. 6B is a side view that partially shows the state at the time of distortion removal. FIG. 6C is a side view that partially shows the state of the work after cutting. FIG. 6A shows the state where distortion 25 appears on the frictional surface of the work 2. After that, by use of the distortion-removal apparatus 22 shown in FIGS. 4 and 5, extrusion of the distortion 25 of the surface is ground off. FIG. 6B shows the state after such grinding.

In FIG. 6B, large distortion is removed, but distortion has not been removed completely. Here, therefore, the surface is ground by use of the aforesaid grinding apparatus 1 to make the frictional surface flatter. In this grinding process, it is possible to obtain the flat surface as desired, the state of which is shown in FIG. 6C. After these processes, large irregularities are removed almost completely.

In accordance with the present invention that has been described above, it is possible to obtain the following effects:

With the present invention, cutting process of friction material is performed in oil, thus making it possible to prevent the temperature from rising due to cutting.

Also, the grinding stone and the work are relatively rotate in oil, and load is given by means of oil pressure to enable the grinding stone and the work to be in contact, thus preventing the temperature from rising due to cutting.

Also, in accordance with the present invention, radially extended grooves are provided for the cutting surface of a grinding stone, hence making it possible to exhaust chips externally and prevent the friction material and grinding store from being packed by chips.

In accordance with the present invention, in a method for forming the frictional surface of a lockup clutch that produces the frictional surface by cutting process given to the friction material, the cutting process is performed in such a manner that only the load of work's own weight is given to the rotating grinding stone. Thus, the process is executable without giving deformation to material, and highly precise flatness of the surface is obtainable.

In accordance with the present invention, the aforesaid additional cutting process is performed subsequent to the cutting process performed by giving only the load of work's own weight to the rotating grinding stone. Therefore, it becomes possible to obtain a flat frictional surface in a short period of time.

What is claimed is:

1. A method for forming the frictional surface of a lockup clutch to form the frictional surface by giving cutting process to a friction material, comprising the step of:
performing said cutting process in oil.

2. A method for forming the frictional surface of a lockup clutch according to claim 1, wherein a grinding stone and a work rotate relatively, and said cutting process is performed by giving a load exerted by oil pressure to enable said grinding stone and said work to be in contact.

3. A method for forming the frictional surface of a lockup clutch according to claim 1, wherein radially extended grooves are provided for the cutting surface of said grinding stone.

4. A method for forming the frictional surface of a lockup clutch according to claim 2, wherein radially extended grooves are provided for the cutting surface of said grinding stone.

5. A method for forming the frictional surface of a lockup clutch to form the frictional surface by giving cutting process to a friction material, comprising the step of:
performing said cutting process by giving only the load of work's own weight to a rotating grinding stone.

6. A method for forming the frictional surface of a lockup clutch according to claim 1, wherein cutting process is performed by giving only the load of work's own weight to a rotating grinding stone before cutting process in oil.

7. A method for forming the frictional surface of a lockup clutch according to claim 2, wherein cutting process is performed by giving only the load of work's own weight to a rotating grinding stone before the grinding stone and the work rotate in oil and cutting process is performed by giving the load exerted by oil pressure to enable said grinding stone and said work to be in contact.

8. A method for forming the frictional surface of a lockup clutch according to claim 3, wherein cutting process is performed by giving only the load of work's own to a rotating grinding stone before the graining stone provided with radially extended grooves on the cutting surface therefore and the work rotate relatively and the load exerted by oil pressure is given to enable said grinding stone and said work to be in contact.

9. A piston used for a lockup clutch having the frictional surface manufactured by a method according to claim 1.

10. A piston used for a lockup clutch having the frictional surface manufactured by a method according to claim 5.
